(19) United States
(12) Patent Application Publication
(10) Pub. No.: US 2008/0019811 A1
(43) Pub. Date: Jan. 24, 2008

(54) METHOD AND APPARATUS FOR VERTICAL WAFER TRANSPORT, BUFFER AND STORAGE

(76) Inventors: Michael Krolak, Los Gatos, CA (US); Roger G. Hine, Menlo Park, CA (US); Anthony C. Bonora, Portola Valley, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 11/775,755

(22) Filed: Jul. 10, 2007

Related U.S. Application Data
(60) Provisional application No. 60/819,979, filed on Jul. 11, 2006.

(51) Int. Cl. B65G 65/02; B65G 1/00; B65G 65/32; B65G 65/38

(52) U.S. Cl. 414/304; 198/347.1; 414/288; 414/808

(57) ABSTRACT

A substrate support and transport system for substrates to be processed is provided. The system includes a container supporting a plurality of substrates in a substantially vertical orientation, where the container has an access door surrounded by a flange defined on a top surface. The system includes a conveying system supporting a bottom surface of the container opposing the top surface. The conveying system is configured to enable removal of the container from the conveying system to a processing tool while the plurality of substrates is in the substantially vertical orientation. The system further includes a receiving module for a processing tool configured to accept the container from the conveying system. The receiving module is configured to move the container in a two dimensional plane defined within the receiving module. A container holding the substrates in a substantially vertical orientation and a method for transporting and storing substrates is provided.

### CLAIM OF PRIORITY

The present application claims priority under 35 U.S.C. §119(e) from U.S. Provisional Patent Application No. 60/819,979, filed Jul. 11, 2006, which is incorporated by reference in its entirety for all purposes.

### BACKGROUND

Historically, semiconductor substrates have been transported in a horizontal orientation. Since the tools that process these substrates, such as etch, deposition, and cleaning tools, perform the respective processing while the substrates are horizontally oriented, the transporting and storage in the same orientation was acceptable. However, as the size of the substrates being processed continues to increase, the footprints for the transporting and storage equipment similarly increases. This increase in size has caused a corresponding increase in the processing area for the manufacturing facility. However, there is a desire to reduce the square footage of the manufacturing facility, especially in light of the continuing automation and minimization of human contact with the processing operations to further increase yield and quality. With the introduction of the 450 mm diameter wafer, the size issues related to the storage and transportation of the substrates in a horizontal orientation exacerbate these problems further.

As a result, there is a need to solve the problems of the prior art to provide an alternative system and method for transporting and storing substrates while minimizing the footprint for the facility in which the processing operations will occur.

### SUMMARY

This invention provides a system for transporting substrates in a substantially vertical orientation. It should be appreciated that the present invention can be implemented in numerous ways, including as a method, a system, or an apparatus. Several inventive embodiments of the present invention are described below.

In one embodiment of the invention, a substrate support and transport system for substrates to be processed is provided. The system includes a container supporting a plurality of substrates in a substantially vertical orientation, where the container has an access door surrounded by a flange defined on a top surface of the container. The system includes a conveying system supporting a bottom surface of the container opposing the top surface. The conveying system is configured to enable removal of the container from the conveying system to a processing tool while the plurality of substrates is in the substantially vertical orientation. The system further includes a receiving module for a processing tool configured to accept the container from the conveying system. The receiving module is configured to move the container in a two dimensional plane, as well as a three dimensional plane, defined within the receiving module.

In another embodiment, a system for transporting a substrate container is provided. The system includes a conveying mechanism supporting the substrate container and substrates contained therein in a substantially vertical orientation, which includes an orientation of up to ten degrees from a vertical plane of the container. The conveying mechanism includes a base along which a bottom surface of the substrate container moves. The conveying mechanism further includes a side extension extending from the base, where the side extension provides lateral support for the substrate container. The conveying mechanism includes a substrate container removal assembly configured to remove the substrate container from the conveying mechanism while maintaining the substrates in a substantially vertical orientation. The system includes a wafer extraction tool configured to extract one of the substrates in the substantially vertical orientation from the substrate container.

In yet another embodiment, a container for transporting a plurality of substrates in a substantially vertical orientation is provided. The container includes a base and sides extending from each edge of the base. The container includes a top opposing the base and affixed to each of the sides. The top has a moveable door enabling access into a cavity defined between the base, the top, and the sides. The base includes stops for supporting each of the plurality of substrates, wherein an inner surface of the moveable door includes stops opposing the stops on the base so that when the moveable door is closed each of the substrates is supported in the substantially vertical orientation through the stops.

In still yet another embodiment, a method for transporting and storing substrates for semiconductor manufacturing operations is provided. The method initiates with placing a substrate into a container in a substantially vertical orientation. The method includes transporting the container along a pathway wherein a direction of the transporting is coincident with a planar surface of the substrate. The method further includes removing the container from the pathway in a direction that is orthogonal with the planar surface of the substrate. The method then advances to removing the substrate from the container while the substrate remains in the substantially vertical orientation.

In another embodiment, an equipment front end module (EFEM) for a processing tool is provided. The EFEM includes a container removal assembly configured to remove a container having substrates oriented in a substantially vertical orientation from a conveying system. The container removal assembly is configured to move the container in a two dimensional plane defined within the EFEM. The EFEM has a plurality of racks configured to accept multiple containers for storage, wherein each of the multiple containers are stored so that substrates within the multiple containers remain in the substantially vertical orientation.

Other aspects and advantages of the invention will become apparent from the following detailed description, taken in conjunction with the accompanying drawings, illustrating by way of example the principles of the invention.

### BRIEF DESCRIPTION OF THE DRAWINGS

Aspects of the present invention will become apparent from the following detailed description, taken in conjunction with the accompanying drawings, illustrating by way of example the principles of the invention.

FIG. 1 is a simplified schematic diagram illustrating a side elevation view of a system for transporting substrates in a substantially vertical manner in accordance with one embodiment of the invention.

FIG. 2 is a simplified schematic diagram illustrating a plan view of the vertical transportation system in accordance with one embodiment of the invention.

FIG. 3 is a simplified schematic diagram illustrating a side elevation view of the vertical transport system in accordance with one embodiment of the invention.

FIG. 4 is a simplified schematic diagram illustrating a more detailed view of the wafer transfer mechanism that transfers the containers from the conveyor into the EFEM in accordance with one embodiment of the invention.

FIGS. 5A through 5C illustrate exemplary simplified schematic diagrams of a vertical transport pod in accordance with one embodiment of the invention.

FIG. 6 is a simplified schematic diagram illustrating a top loading pod and conveying mechanism, wherein the conveying mechanism includes wheels in accordance with one embodiment of the invention.

FIG. 7 illustrates a schematic diagram of transporting a vertical pod on a hanger conveyor in accordance with one embodiment of the invention.

FIGS. 8A and 8B are simplified schematic diagrams illustrating an alternative top hanging conveying system to the system illustrated in FIG. 7.

FIG. 9 is a simplified schematic diagram illustrating a flanged pod being hung from a top conveyor in yet another embodiment of the invention.

FIG. 10 is a simplified schematic diagram illustrating a wafer extraction mechanism in accordance with one embodiment of the invention.

### DETAILED DESCRIPTION

An invention is described for a system and method for transporting, buffering and storing substrates in a vertical orientation. It will be obvious, however, to one skilled in the art, that the present invention may be practiced without some or all of these specific details. In other instances, well known process operations have not been described in detail in order not to unnecessarily obscure the present invention.

The embodiments described herein provide for a semiconductor wafer handling system where the semiconductor wafers are transported in a vertical orientation. It should be appreciated that the semiconductor wafers may be referred to as substrates. The semiconductor wafers may be contained within a top opening pod in one embodiment. The top opening pod provides an access door on a top surface enabling an end effector or robot to access the vertically oriented wafers. It should be noted that the terms top opening pod, Pod, and container may be used interchangeably. Alternatively, the semiconductor wafers may be transported vertically within a clean tunnel and delivered to a processing tool therefrom in another embodiment. In this embodiment, the substrates may be supported in an open or non-sealable container that is transported on a belt, wheels, etc. within the clean tunnel. It should be appreciated that orienting the wafers vertically during transportation provides for spatial efficiency, i.e., efficient use of floor space within a manufacturing facility. In the system, the container embodiment would provide for moving the container between processing tools in a processing facility through an automated material handling system (AMHS). The AMHS would transport containers having wafers oriented substantially vertically therein between the tools of the processing facility. The containers would be transferred from the AMHS to a tool's equipment front end module (EFEM). The tool's EFEM would then translate the wafer or container to a horizontal position so that the processing of the wafer can proceed.

The embodiments described herein enable spatially efficient transport, queuing, and substrate extraction, as well as simplified load port design and access to the substrates within the container as described in more detail below. Furthermore, the vertical orientation of the wafer minimizes wafer sag and vibration effects, which are becoming more pronounced for horizontal transport and storage of wafers, especially as the wafer size transitions from 300 mm wafers to 450 mm wafers. It should be appreciated that the center position of the wafer being extracted in the vertical position is easily and repeatably ascertainable since the weight of the wafer will assist in the placement of the wafer on the wafer extraction tool.

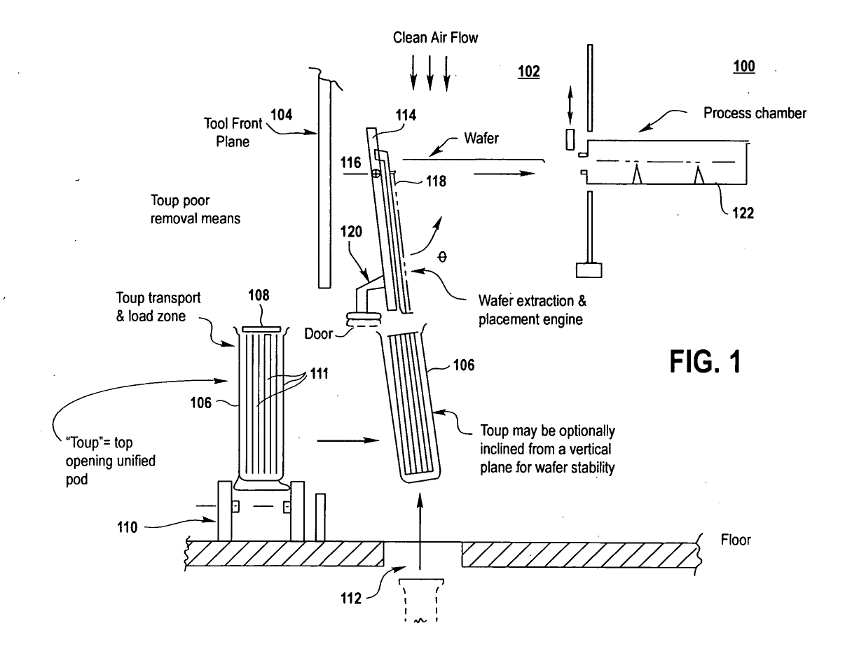

FIG. 1 is a simplified schematic diagram illustrating a side elevation view of a system for transporting substrates in a substantially vertical manner in accordance with one embodiment of the invention. The system in FIG. 1 includes process tool 100 and EFEM 102. EFEM 102 has front plane 104 and in one embodiment, a conveying system will transport top opening pod 106 through conveyor 110 to be placed into EFEM 102. Top opening pod 106 may be a sealed container having access door 108 for access to substrates 111 contained therein. One skilled in the art will appreciate that conveying system 110 may be a belt-type conveyor, wheel-driven conveyor, rail guided vehicles (RGV), or automated guided vehicles (AGV) suitable to transport the top opening pod 106. When top opening pod 106 has arrived at the entrance into EFEM 102, top opening pod 106 is translated into EFEM 102. Thus, substrates 111 are transported in a direction that coincides with a planar surface of the vertically oriented substrate on conveyor 1 10. Once top opening pod 106 is at the entrance to EFEM 102, the top opening pod is then transported in a direction that is orthogonal to the planar surfaces of vertically oriented substrates 111. In another embodiment, top opening pod 106 may be lifted from a “below the floor” conveying system.

Still referring to FIG. 1, top opening pod 106 may be inclined from a vertical plane relative to the floor in order to pick a substrate from the top opening pod and to provide wafer stability once inside EFEM 102. Top opening pod 106 moves on conveyor 110 in the front area of the destination processing tool. In one embodiment, after top opening pod 106 stops in front of the destination tool, container 106 is transferred through a transfer mechanism that picks the container off conveyor 110 and moves the container into EFEM 102. One skilled in the art will appreciate that the container may be tilted by a specialized load port to provide predictable positioning of the substrates. Of course, door 108 must be moved in order to enable access into top opening pod 106. In one embodiment, substrate extraction mechanism 114 includes door opening arm 120, which will attach to door 108 in order to move or remove or open the door. Door 108 may be completely removed in one embodiment or opened but still affixed to top opening pod 106. For example, if door 108 is hinged, the door may be opened by arm extension 120 engaging the door and opening the door through motion provided by wafer extraction mechanism 114. Alternatively, where door 108 is removable, wafer extraction mechanism 114 is configured to remove the door. One skilled in the art will appreciate that numerous mechanisms may accomplish this functionality and that the opening or removal of the door is not limited to the specific mechanisms described herein as any suitable removal or opening mechanism may be employed. For example, arm extension 120 may include a key to mate with a key way on door 108 and through a twisting motion the door may be unlocked for removal or opening. Of course, other known mechanical configurations for door 108 and the removal or opening of the door may be integrated with the embodiments described herein.

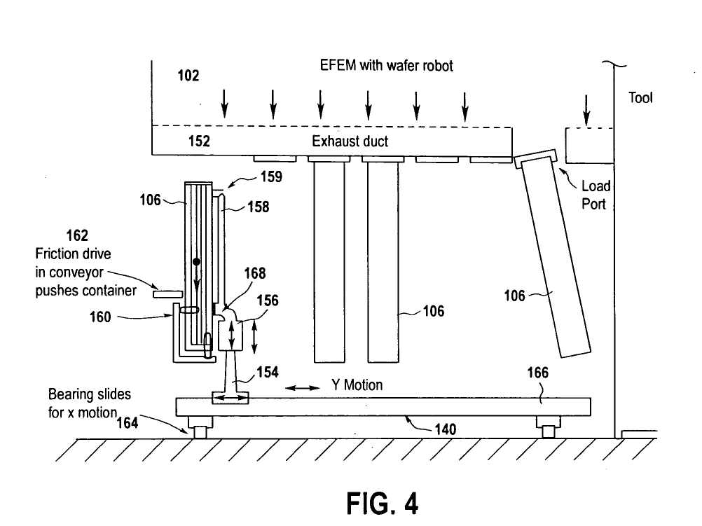

Once door 108 is opened, wafer transfer mechanism 114 will include an end effector 118 which can reach down into container 106 in order to extract a substrate. Wafer extraction mechanism 114 is capable of rotating the extracted substrate in order to orient the substrate in a horizontal position for insertion into process chamber 122 of the processing tool 100. Wafer extraction mechanism 114 is configured to rotate around pivot point 116 in one embodiment in order to provide for the transition between vertical and horizontal transitions. In an alternative embodiment, top opening pod 106 may be transported through a conveying system located beneath the floor of the processing facility, as illustrated in region 1 12. Here top opening pod 106 would be lifted from the floor conveyor into EFEM 102. It should be appreciated that the embodiments described herein are compatible with both “below the floor” or “on the floor” transport/conveying systems. Upon completion of processing within process chamber 122, the processed substrate is removed through and opening of the process chamber and replaced into top opening pod 106 through wafer transfer mechanism 114. In one embodiment, the processing tool may include an end effector that is configured to extend directly into the tilted pod for extraction of the wafer and subsequent movement into the processing tool. As mentioned above, the door for the top opening pod may be an opening door or a removable door. In another embodiment, the door may be a retractable flexible membrane door that may be retracted over rollers, as well as other known retracting means, such as through timing belts, etc. It should be noted that the door as described herein provides access to the substrates and that access may be achieved through opening, removing, sliding, or retracting the door. In addition, the door functions to seal the substrates within the top opening pod to prevent particulates from entering inside of the pod during transportation or storage of the pod. It should be noted that for ease of illustration, the sealing mechanism around container 106 to maintain the controlled environment within EFEM 102 is not illustrated. However, as mentioned in FIG. 4, a flexible seal may be provided so that as container 106 is tilted, the integrity of the controlled environment is maintained.

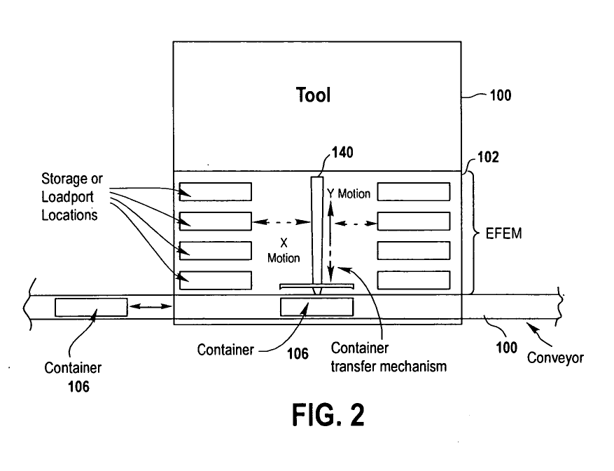

FIG. 2 is a simplified schematic diagram illustrating a plan view of the vertical transportation system in accordance with one embodiment of the invention. EFEM 102 is located in front of processing tool 100. Conveyor 110 runs under an outer edge of EFEM 102. Of course, conveyor 110 may run outside EFEM 102 and the containers are moved into EFEM 102 as illustrated in FIG. 1. In addition, conveyor 110 may run below the floor. In one embodiment, a tunnel may be disposed below the floor for the transportation of the substrates. Containers 106 are transported along conveyor 110 and arrive at a destination in front of EFEM 102. Container transfer mechanism 140 is then used to transfer container 106 to an appropriate storage area or load port location within EFEM 102. Container transfer mechanism 140 moves containers off of the conveyor and into EFEM 102 via Y axis motion and then shifts the removed containers to either side of EFEM 102 through X axis motion. It should be appreciated that the container positions illustrated within EFEM 102 may either be buffer storage positions or load port positions. In addition, it may be preferred to have one load port on each side of the transfer mechanism since two load ports allow the tool to be accessing wafers at one load port while a second load port is being loaded or unloaded. As will be illustrated in more detail below, containers 106 may be supported or hanging by a collar on a top edge of the container's surface within EFEM 102.

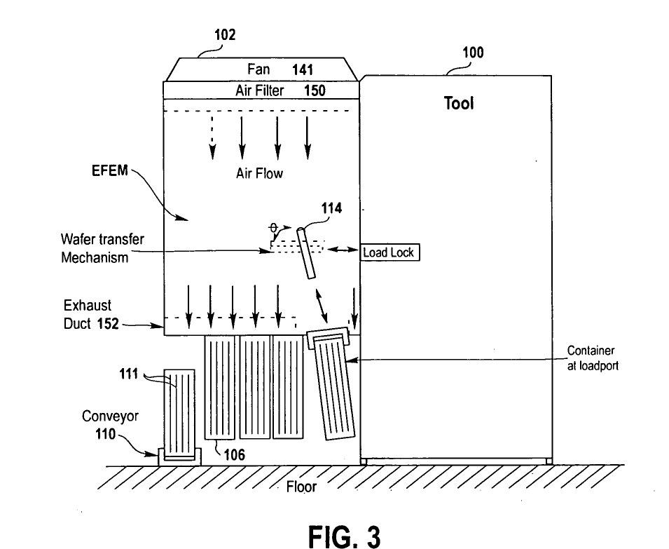

FIG. 3 is a simplified schematic diagram illustrating a side elevation view of the vertical transport system in accordance with one embodiment of the invention. In FIG. 3, tool 100 will process the substrate and EFEM 102 delivers the substrates to be processed and removes process substrates from the front of tool 100. Here, EFEM 102 includes fan 141 and filter 150 to provide air flow and a controlled environment within a region encompassed by EFEM 102. Top opening pod 106 is stored within a bottom region of EFEM 102. Wafer extraction mechanism 114 removes wafers from top opening pod 106 for processing and returns wafers to top opening pod 106 upon completion of the processing. Exhaust ducts 152 provide for the removal of air from a region above stored top opening pods 106 and maintain the laminar flow within EFEM 102. It should be noted that since containers 106 are hung from the bottom support of EFEM 102 in one embodiment, the air being supplied to the EFEM is allowed to escape through exhaust ducts 152. A top opening pod 106, which is in a load port area, is tilted with respect to a vertical axis of the top opening pod for extraction of the wafer from the top opening pod in one embodiment. In an alternative embodiment, rather than having to tilt top opening pod 106 in the load port, the substrates may be placed in a tilted position within the top opening pod. That is, rather than having the substrates at 90 degrees relative to a base surface of the top opening pod, i.e., the substrates are parallel with a vertical plane of the top opening pod, the substrates may be offset by up to ten degrees from the vertical in one embodiment. In this manner, tilting of the top opening pod would be unnecessary. It should be appreciated that the nesting within top opening pod 106 may be configured so that the substrates are slightly angled with respect to a vertical plane of the top opening pod. In one embodiment, the substrates are at an angle of ten degrees or less with respect to the vertical plane of the top opening pod. The nesting within the top opening pod includes stops located at the bottom surface of the top opening pod for support of the substrate. In addition, opposing stops may be placed against an inner surface of the door of the top opening pod to provide the support. It should be noted that by offsetting the opposing stops, along with slotted slots along the inner sides of the top opening pod, the angle of inclination is achieved in one embodiment. It should be apparent that the angle of ten degrees or less is exemplary and not meant to be limiting, as angles of inclination greater than ten degrees may be incorporated. For example, an angle of inclination of less than twenty degrees may be incorporated, as any suitable angle that provides for stabilization and is efficient from a storage footprint point of view may be selected.

FIG. 4 is a simplified schematic diagram illustrating a more detailed view of the container transfer mechanism that transfers the containers from the conveyor into the EFEM in accordance with one embodiment of the invention. Container transfer mechanism 140, which may be referred to as a substrate container removal assembly or a container movement assembly, includes base 166 on top of which container support mechanism 154 is attached. Base 166 includes bearing slides 164 for X axis motion in one embodiment. Container transfer mechanism may also be referred to as a wafer transfer mechanism as the wafers or substrates are within the container and moved when the container moves. Container support mechanism 154 is configured to slideably move along base 166 to provide Y motion. In addition, container support mechanism 154 can extend vertically through extension mechanism 156. In one embodiment, an end of container support mechanism 154 will attach to a receiving feature 159 of container 106. For example, an end of container support mechanism 154 may fit into a notch defined on receiving feature 159 of container 106. The notch may be conically shaped to accept the end of the container support mechanism in a number of orientations, similar in concept to a kinematic pin. Support pad 168 will provide for stability as container support mechanism 154 lifts the container from conveyor 110. As illustrated in this embodiment, conveyor 110 may provide friction drive wheels 162 to push container along the conveyor. Container 106 may include guide wheels 160 mounted thereon which freely rotate as the friction drive wheel 162 imparts motion to container 106 in this embodiment. It should be appreciated that once container support mechanism 154 has secured container 106, container support mechanism 154 may move in a Y axis direction in order to insert container 106 to an appropriate slot within a support of EFEM 102. In one embodiment, container 106 is supported by resting a bottom surface of a flange on the container supporting surface of EFEM 102. Supported containers 106 may then be conveyed to the load port by container support mechanism 154 and the container at the load port may be tilted for a wafer extraction mechanism to access the wafers contained therein as described above. Tilting of the containers at the load port may occur through a tilting mechanism that grips the top surface of the container at the load port. Alternatively, a bottom portion of the container may be forced to one side to provide the tilting. In either embodiment, the tilted container at the load port maintains a seal so that the controlled environment provided by EFEM 102 is maintained. In one embodiment, a flexible seal may accommodate the tilting of the container and still provide a seal to maintain the controlled environment. In another embodiment, container transfer mechanism 140 may present the container directly to the load port either from the racks or the conveying mechanism.

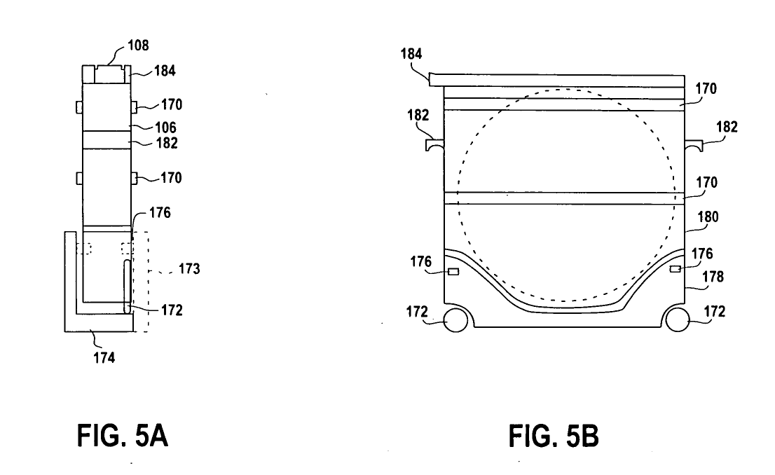

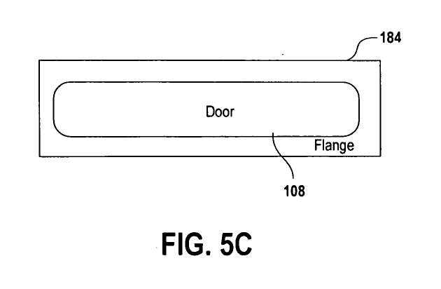

FIGS. 5A through 5C illustrate exemplary simplified schematic diagrams of a vertical transport pod in accordance with one embodiment of the invention. In FIG. 5A, a front end view of the vertical transport pod and a cross section of a guide rail are illustrated in accordance with one embodiment. Vertical transport pod 106, which may be referred to as a container, includes conveyor rail surfaces 170, which may be used to provide support as the vertical transport pod is being transported along a conveyor where the vertical transport pod is not self powered. Door 108 is included on a top surface of vertical transport pod 106. Bottom wheels 172 ride along a bottom surface of rail 174. Side wheels 176 may be included in order to assist in the movement and/or lateral support of vertical transport pod 106 along the conveyor where vertical transport pod 106 is powered. It should be appreciated that conveyor rail surfaces 170 and side wheels 176 are illustrated on vertical transport pod 106 for ease of illustration, and these two features may not be included together, as the conveyor rail surfaces would accommodate a non-powered pod and the side wheels are provided for a powered car. That is, rail surfaces 170 may be used as a friction surface where a belt or wheels on the conveyor provide the drive to move the pod in one embodiment.

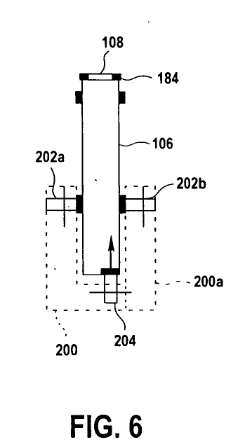

FIG. 5B illustrates a side view of vertical pod 106 in accordance with one embodiment of the invention. As illustrated, vertical pod 106 may be provided in two portions. An enclosure portion, also referred to as a top portion, that encloses the vertically oriented substrates and a bottom portion which detaches from the enclosure portion, wherein the bottom portion provides for the movement along a conveyor make up the two portions in this embodiment. Bottom portion 178 includes bottom wheels 172 and optional side wheels 176. Enclosure portion 180 includes forklift handles 182 and top opening door 108 as well as surrounding flange 184. Conveyor rail surfaces 170 extend along the side of enclosure portion 180. FIG. 5C illustrates a top view of the vertical transfer pod in accordance with one embodiment of the invention. In FIG. 5C, door 108 is surrounded by flange 184. It should be appreciated that wheels 172 of vertical transport pod 106 may be passive or the wheels may be driven. If wheels 172 are driven, then the pod includes a motor or some other means for providing energy or conducting energy from a rail in order to provide movement. If the wheels are passive, then the rail includes a conveying means for propelling the pods forward. This conveying means may be a belt with or without tabs that protrude and push the pods along in one embodiment. The belts may extend for a relatively long distance or a short distance. Alternatively, the belt may have magnets or metal portions that interact with metal or magnet portions of the pods. In this case, the belt may run inside an enclosure that contains any particle contamination. In another embodiment, the belt may be guided by slide surfaces rather than wheels, to reduce complexity, cost and space. Instead of a belt, friction drive wheels may be placed intermittently along the rail to push the pods along, as illustrated in FIG. 6. In one embodiment, the wheels may overlap so that the pod is always in contact with at least one friction drive wheel, or in some areas, it may be acceptable to allow a pod to coast freely. In yet another embodiment, the pods may be driven by a linear motor. One skilled in the art will appreciate that the drives discussed herein for the X, Y, and Z directions may be provided by numerous drives commercially available, such as anti friction slides, timing belts, pulleys, lead screws, pneumatic cylinders, linear motors, rack gears, etc. In yet another embodiment, the pods may include a speed limiting device and the rail may be sloped so that gravity propels the pods forward. Any combination of the above described means for transporting the pods may be used in different portions of the factory. In addition, these drives may be controlled through appropriate microprocessors and associated software capable of achieving the functionality described herein.

The wheels placed on the bottom of the transport pod of FIGS. 5A-5C rather than the conveyor will enable the pod with two wheels to follow curved rails without any loss of motion smoothness in one embodiment. In this embodiment, the rail may curve upward, downward, or sideways and the wheels would be on a truck or some other structure enabling the wheels to pivot to avoid scrubbing, similar to a railroad car. Consequently, the pod will be enabled to move continuously around corners and to merge or diverge paths without stopping. The possibility of curving the rail also would allow twisting of the rail along its primary axis. A twisting rail may be used to transition pods from a vertical orientation to a horizontal orientation in one embodiment. In addition, the wheels on the bottom of the pod reduce the total number of wheels in the system thereby increasing reliability. It should be appreciated that with the wheels on the bottom of the pod the motion smoothness is improved because the wheels may have some suspension and the rails can be longer, smoother sections. Since the rails are of reduced complexity in this embodiment, the reliability of the rails is increased. In one aspect, the reliability of the rails is relatively more important than the reliability of the wheeled pods because a failure in a pod only impacts that pod and its corresponding cargo, wherein a failure of the rail will impact all the traffic on that rail. One skilled in the art will appreciate that the two part pod of FIG. 5B enables cleaning of the enclosure portion without having to be concerned about contamination of the cleaning apparatus by the wheels because the lower portion of pod 106 is detachable from the upper portion.

The bottom portion of the pods shown in FIGS. 5A and 5B include two bottom wheels 172 and four optional side wheels 176, in one embodiment. The two bottom wheels are in each corner of the pod to provide the most stable platform and to efficiently use the available space. The bottom wheels are positioned to one side of the center of gravity of the pod. In FIG. 5A, bottom wheels 172 are illustrated on the right side of the pod. It should be appreciated that this would cause the pod to fall to the left if these were the only support points. The optional side wheels on the left then support the pod against a rail surface there. The two sets of wheels will support the pod in a stable, upright position where the side wheels on the right of the pod will prevent the pod from falling to the right if the pod were pushed that way. The side wheels on the right may also be spring loaded to ensure the pod stays firmly against the left side rail. In one embodiment, right side rail 173 may be removed or omitted so that the pod may be easily removed from the rail and for example, brought into the EFEM. As mentioned above, numerous other embodiments, such as an embodiment where the bottom wheels are included without the side wheels, where the conveying mechanism includes wheels or a belt that interacts with conveyor side rails 170 are possible.

The pod as illustrated in FIG. 5C includes a handling flange 184 on top of the pod and around the door 108. In one embodiment, the door 108 is capable of being opened to enable access to the substrates contained therein. The flange 184 in one embodiment is essentially rectangular with three sides that define measurable datum planes. The load port and handling mechanism can interface these datum planes to position a pod and thus place the wafers inside accurately and repeatably for robotic wafer handling. The pod may also include a handling feature such as forklift grooves on the front and back in order to enable the stacking and storage of the top portion of the pods.

FIG. 6 is a simplified schematic diagram illustrating a top loading pod and conveying mechanism, wherein the conveying mechanism includes wheels in accordance with one embodiment of the invention. Pod 106 is supported within conveyor 200 and conveyor section 200a. Conveyor 200 includes primary support wheel 202a and bottom support drive wheel 204. Conveyor section 200a includes secondary side support wheel 202b. In one embodiment, conveyor section 200a may be eliminated to enable side access to pod 106 for removal from the conveyor and/or placement into the conveyor. In the embodiment of FIG. 6, as opposed to FIGS. 5A through 5C, the wheels are contained within the conveyor rather than on the pod. Pod 106 may have pads or surfaces against which primary support wheels 202a, secondary support wheels 202b, and bottom support wheels 204 make contact in order to provide the necessary motion. One skilled in the art will appreciate that by placing bottom support wheel towards one side of a bottom surface of the vertical pod 106 may cause the vertical pod to tilt. Thus, support wheels 202a and 202b provide the necessary support to keep the vertical pod 106 substantially vertical. With regard to the Figures described herein, it should be noted the wheels may also be replaced by belts in many instances. For example, the wheels 202a, 202b, and 204 of FIG. 6 may be replaced by belts in one embodiment.

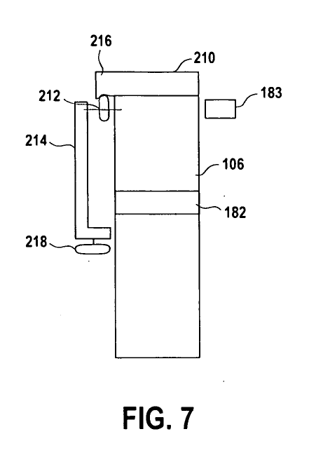

FIG. 7 illustrates a schematic diagram of transporting a vertical pod on a hanger conveyor in accordance with one embodiment of the invention. In this embodiment, pod 106 is configured to be hung from a conveyor and driven by the flange portion 210 rather than driven from a bottom surface of the vertical pod. Flange portion 210 includes an extended hook rail 216 in which wheel 212 will provide the force to impart motion for pod 106 along the conveyor. Conveyor section 214 also includes bottom support wheel 218 in order to stabilize the hanging pod and maintain a substantial vertical orientation. In the embodiment of FIG. 7, a groove within flange 210 engages with wheel 212 to provide a vertical reaction force and an angled reaction force against the groove surface of hook rail 216. In addition, forklift handles 182 are provided on each of the opposing sides of pod 106 in order for a robot to remove and place the vertical pod from and to the conveying system and for stacking the pods. It should be appreciated that containment rail 183 may be optionally placed in some areas of the conveying system. Of course, containment rail 183 may be alternatively embodied as a wheel.

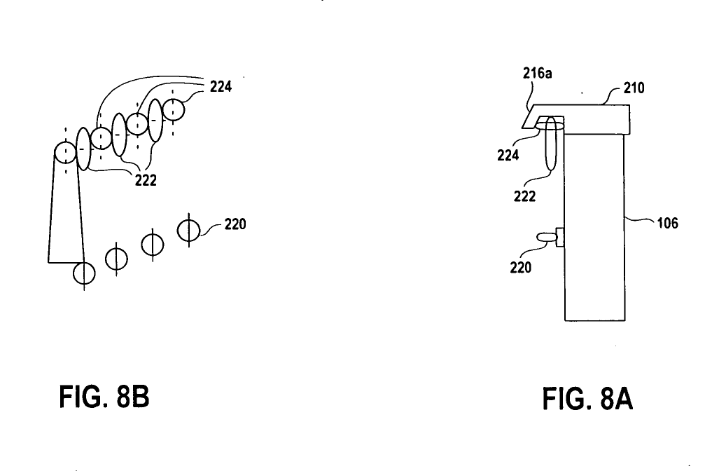

FIGS. 8A and 8B are simplified schematic diagrams illustrating an alternative top hanging conveying system to the system illustrated in FIG. 7. In FIG. 8A, flange portion 210 is constructed differently in that extended hook rail 216a includes a portion that is substantially orthogonal to the hook rail in order to provide and impart motion to pod 106. As illustrated in FIGS. 8A and 8B, vertically disposed wheels 222 and horizontally disposed wheels 224 are alternatively placed along the conveying system in order to impart motion to vertical pod 106. Side wheels 220 are used to stabilize the vertical pod during the transportation. The alternating horizontal and vertical wheels illustrated in FIG. 8B, will reduce scrubbing as vertical pod 106 is transported. In FIG. 8B vertical wheels 222 and horizontal wheels 224 are illustrated in an alternating fashion and would be supported along corresponding rails in order to continuously provide the motion needed for this top hanging embodiment.

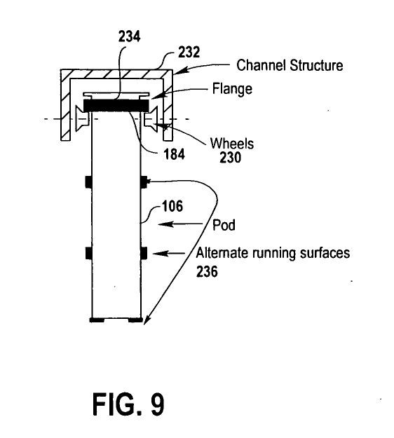

FIG. 9 is a simplified schematic diagram illustrating a flanged pod being hung from a top conveyor in yet another embodiment of the invention. In this embodiment, pod 106 is held captive through channel structure 232 of the conveying system. One skilled in the art will appreciate that sections of channel structure 232 may be open to allow the pod to pass vertically therethrough in order to provide the necessary removal means. Furthermore, it should be appreciated that the embodiment of FIG. 8 may be used in conjunction with other support configurations illustrated in the previous figures. In one embodiment, pod 106 may transition from a top supporting conveyor such as the one illustrated with respect to FIG. 8 to a bottom supporting conveyor or rail, e.g., those illustrated with reference to FIGS. 5A-6, which would enable for merging and diverging traffic. Channel structure 232 supports wheels 230 which are used to grip a bottom surface of flange 184 in order to impart motion to pod 106. Door 234 enables access into the vertical pod and running surfaces 236 may be used to provide support for the vertical pod if necessary. In this embodiment, the top supported section may be used as storage racks or as part of the gripper for a pod handling robot. In another embodiment, the top supported section may be used as a transition section between two areas where the pod is supported by other running surfaces.

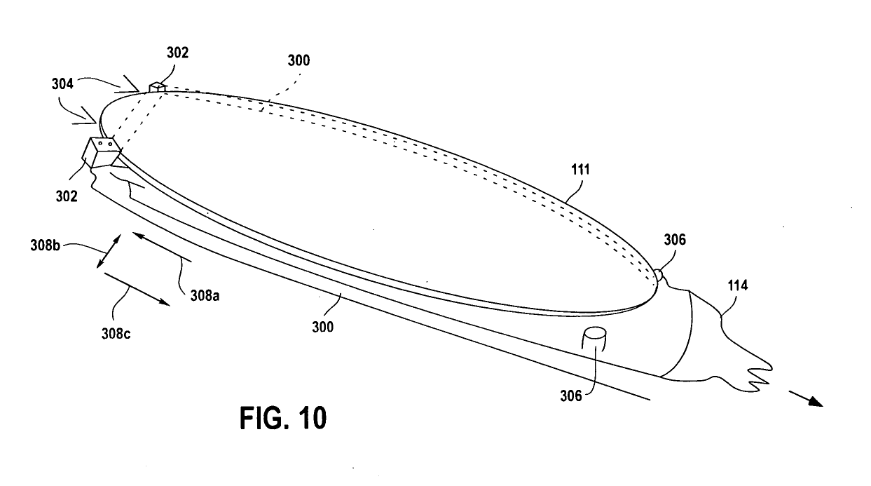

FIG. 10 is a simplified schematic diagram illustrating a wafer extraction mechanism in accordance with one embodiment of the invention. Wafer extraction mechanism 114 includes a pair of arms 300 in which stops 302 are disposed at an end of each of the arms. Wafer extraction mechanism 114 is capable of moving in the motion represented by arrows 308a-c in order to transfer substrate 111. Within a pod, substrate 111 may rest in a vertical orientation against stops 304 of the pod or nest within the pod. Wafer extraction mechanism 114 will extend into the pod below a surface of the vertically oriented substrate and move closer to the surface of the substrate so that stops 302 extend above an opposing surface of substrate 111. Wafer extraction mechanism then removes substrate 111 as the weight of the substrate rests against stops 302 when the substrate is substantially vertical. As discussed above, the substrate may be about 10 degrees off of vertical for stability purposes. Rest stops 306 are disposed at opposing ends of arms 300 that the substrate rest on top of. Depending on the application, rest stops 306 may be a slippery surface or a frictional surface. In yet another embodiment, rest stops 306 may include a vacuum channel or channels to assist in the support of the substrate during the transportation of the substrate. Suitable materials for rest stops 306 include KELREZ™, TEFLON™, or other suitable fluoropolymers in one embodiment. Of course, other materials that are relatively inert and compatible with the wafer being supported and the operating environment are capable of being used. In one embodiment, the wafer extraction mechanism may include an end effector that can grip an edge or bottom surface of the substrate for transportation. Further details on this type of end effector are supplied in U.S. application Ser. No. 11/483,366, which is incorporated herein by reference for all purposes. It should be appreciated that while the wafer extraction mechanism of FIG. 10 illustrates the removal of one substrate at a time, this is not meant to be limiting as multiple substrates may be contemporaneously extracted by the same wafer extraction mechanism or by multiple wafer extraction mechanisms.

In summary, the embodiments described herein provide for the transportation of substrates in a substantially vertical orientation. The container described herein may be composed of any material suitable for semiconductor procession operations and the storage of the semiconductor wafers. The material will be non-shedding and in one embodiment is a plastic material. In addition, one skilled in the art will appreciate that the top opening pod described herein may accommodate any number of substrates. In one embodiment, the top opening pod accommodates about 25 substrates in the vertical orientation with a pitch of 10 millimeters. However, within the top opening pod the substrates are spaced apart in any suitable spacing so that the wafer extraction mechanism can extend between the substrates and engage one of the substrates as illustrated with reference to FIG. 10. Furthermore, the top opening pod may include less or more than 25 substrates as required by the nature of the application. One skilled in the art will appreciate that by orienting the substrate vertically, valuable floor space may be saved. Additionally, it should be noted that the invention is not limited to the actual structures providing the support and lifting mechanisms as these are exemplary structures. That is, any structure accomplishing the functionality described herein may be integrated into the embodiments described above.

By now, those of skill in the art will appreciate that many modifications, substitutions, and variations can be made in and to the materials, apparatus, configurations, and methods of the substrate transferring system of the present invention without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalence.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims. It should be appreciated that exemplary claims are provided below and these claims are not meant to be limiting for future applications claiming priority from this application. The exemplary claims are meant to be illustrative and not restrictive.

What is claimed is:

1. A substrate support and transport system for substrates to be processed, comprising:
a container supporting a plurality of substrates in a substantially vertical orientation, the container having an access door defined on a top surface, the access door being surrounded by a flange;
a conveying system supporting a bottom surface of the container opposing the top surface, the conveying system configured to enable removal of the container from the conveying system to a processing tool while the plurality of substrates are in the substantially vertical orientation; and
a receiving module for a processing tool configured to accept the container from the conveying system, the receiving module configured to move the container in a two dimensional plane defined within the receiving module.

2. The system of claim 1, wherein the receiving module includes a substrate extraction tool configured to remove one of the plurality of substrates from the container through the access door while the substrate is in the substantially vertical orientation.

3. The system of claim 2, wherein the substrate extraction tool includes an arm extension configured to open the access door.

4. The system of claim 1, wherein the flange provides support for storage of the container within the receiving module.

5. The system of claim 1, wherein the receiving module includes a container transfer mechanism that removes the container from the conveying system and wherein removal of the container from the conveyer system is in a direction that is orthogonal to a planar surface of one of the plurality of substrates in the substantially vertical orientation.

6. The system of claim 5, wherein the container transfer mechanism includes a support arm configured to engage with a receiving feature of the container, the support arm configured to lift the container when engaged with the receiving feature.

7. The system of claim 6, wherein the support arm includes a side extension, the side extension providing lateral support to the container while the container is lifted by the support arm.

8. The system of claim 6, wherein the receiving feature is a protrusion extending from a side of the container, the protrusion having a notch defined in a bottom surface, the notch configured to mate with a top surface of the support arm.

9. A system for transporting a substrate container, comprising:
a conveying mechanism supporting the substrate container and substrates contained therein in a substantially vertical orientation, the conveying mechanism including a base along which a bottom surface of the substrate container moves, the conveying mechanism including a side extension extending from the base, the side extension providing lateral support for the substrate container, the conveying mechanism further including a substrate container removal assembly configured to remove the substrate container from the conveying mechanism while maintaining the substrates in a substantially vertical orientation; and
a wafer extraction tool configured to extract one of the substrates in the substantially vertical orientation from the substrate container.

10. The system of claim 9, wherein the substrate container removal assembly lifts the substrate container from the conveying mechanism and transports the substrate container in a direction substantially orthogonal to a direction of travel on the conveying mechanism.

11. The system of claim 9, wherein the wafer extraction tool includes an arm extension configured to attach to and open a door of the substrate container thereby enabling access to the substrates.

12. The system of claim 9, wherein the wafer extraction tool is configured to extend into the substrate container and extract one of the substrates in the substantially vertical orientation from the substrate container.

13. The system of claim 12, wherein the substrate container is inclined at a maximum of 10 degrees from a vertical plane prior to the wafer extraction tool extracting the one of the substrates.

14. The system of claim 9, wherein the wafer extraction tool removes one of the substrates in the substantially vertical orientation and transitions the one of the substrates to a horizontal orientation.

15. The system of claim 9, wherein the wafer extraction tool includes a support arm having a grip stop disposed at an end of the support arm, the wafer extraction tool configured to extend under a side of one of the substrates in the substrate container, the wafer extraction tool configured to translate laterally so that a top surface of the grip stop extends beyond an opposing side of the one of the substrates and the grip stop is below a diameter of the one of the substrates.

16. A sealable container for environmentally isolating, supporting, and transporting a plurality of substrates in a substantially vertical orientation, comprising:
a base;
sides extending from each edge of the base;
a top opposing the base and affixed to each of the sides, the top having a moveable door enabling access into a cavity defined between the base, the top, and the sides, the base including stops for supporting each of the plurality of substrates, opposing sides including guides for supporting each of the plurality of substrates in the substantially vertical orientation, wherein an inner surface of the moveable door includes stops opposing the stops on the base so that when the moveable door is sealed each of the substrates is supported in the substantially vertical orientation through the stops and the guides.

17. The container of claim 16, wherein the stops and the guides are configured to support each of the substrates at an incline of a maximum of ten degrees relative to a vertical plane of the container.

18. The container of claim 16, wherein the container includes a top portion supporting the plurality of substrates and a bottom portion, the top portion detachable from the bottom portion, the bottom portion including bottom wheels extending past a bottom surface of the bottom portion and enabling movement of the bottom portion along a rail over which the container is disposed.

19. The container of claim 18, wherein the wheels are motorized.

20. The container of claim 18, wherein the wheels are passive.

21. The container of claim 18, wherein the bottom portion includes side wheels extending from a side surface of the bottom portion for lateral support during movement of the container.

22. The container of claim 16, wherein the container includes a top portion supporting the plurality of substrates and a bottom portion, the top portion detachable from the bottom portion, the top portion having a curved bottom surface conformal to a shape of the substrates, the top portion including lift handles extending outwardly in a direction coincident with a planar surface of the substrates in the substantially vertical orientation.

23. The container of claim 16, wherein the flange includes a hook rail extending from one side of the flange, the hook rail configured to mate with driven wheels of a conveying mechanism to transport the container.

24. The container of claim 23 wherein the sides coplanar with a planar surface of the substrates includes a support strip protruding from the sides and extending along a length of the sides.

25. A method for transporting and storing substrates for semiconductor manufacturing operations, comprising:
placing a substrate into a container in a substantially vertical orientation;
transporting the container along a pathway wherein a direction of the transporting is coincident with a planar surface of the substrate;
removing the container from the pathway in a direction that is orthogonal with the planar surface of the substrate; and
removing the substrate from the container while the substrate remains in the substantially vertical orientation.

26. The method of claim 25, wherein the placing the substrate into the container in the substantially vertical orientation includes inclining the substrate between about 1 to about 10 degrees from a vertical plane of the container.

27. The method of claim 25, wherein the transporting the container along a pathway wherein a direction of the transporting is coincident with a planar surface of the substrate includes supporting the container from a bottom surface and at least one side surface during the transporting.

28. The method of claim 25, wherein the transporting the container along a pathway wherein a direction of the transporting is coincident with a planar surface of the substrate includes supporting the container from a bottom surface of a flange surrounding a perimeter of a top surface of the container.

29. The method of claim 25, wherein the removing the substrate from the container while the substrate remains in the substantially vertical orientation includes inclining the container at a maximum angle of ten degrees from a vertical plane of the container.

30. The method of claim 25, wherein the removing the container from the pathway in a direction that is orthogonal with the planar surface of the substrate includes,
lifting from a single side of the container to remove the container from the pathway;
moving the lifted container to a storage rack; and
slidably engaging a bottom surface of a flange surrounding a perimeter of a top surface of the container with a support shelf to store the container.

31. An equipment front end module (EFEM) for a processing tool, comprising:
a container removal assembly configured to remove a container having substrates oriented in a substantially vertical orientation from a conveying system, the container removal assembly further configured to move the container in a two dimensional plane defined within the EFEM, the EFEM having a plurality of racks configured to accept multiple containers for storage, wherein each of the multiple containers are stored so that substrates within the multiple containers remain in the substantially vertical orientation.

32. The EFEM of claim 31, wherein the plurality of racks are configured to support a bottom surface of a top flange of the container.

33. The EFEM of claim 31, wherein the container removal assembly removes the container from the conveying system and wherein removal of the container from the conveyer system is in a direction that is orthogonal to a planar surface of one of the plurality of substrates in the substantially vertical orientation.

34. The system of claim 33, wherein the container removal assembly includes a support arm configured to engage with a receiving feature of the container, the support arm configured to lift the container when engaged with the receiving feature to place the container onto one of the plurality of racks.

35. The EFEM of claim 34, further comprising:
a loadport configured to accept the container from one of the plurality of racks, the load port providing an opening into a controlled environment of the EFEM.

36. The EFEM of claim 35, wherein the load port is configured to tilt the container to about ten degrees from vertical.
